(19) United States
(12) Patent Application Publication
(10) Pub. No.: US 2017/0010996 A1
(43) Pub. Date: Jan. 12, 2017

(54) SYSTEM FOR EXPANSION OF INPUT/OUTPUT PORTS OF A COMPUTER

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: SONG MA, Shenzhen (CN); MENG-LIANG YANG, Shenzhen (CN)

(21) Appl. No.: 14/826,705

(22) Filed: Aug. 14, 2015

(30) Foreign Application Priority Data
Jul. 9, 2015 (CN) 201510399301.0

(51) Int. Cl. G06F 13/40; G06F 13/42

(52) U.S. Cl. CPC G06F 13/4022; G06F 13/4282; G06F 13/4068

(57) ABSTRACT

A computer I/O port system includes a CPU, a plurality of switches and a plurality of I/O ports connecting with each other by PCI Express buses. A first switch receives a pair of PCI Express signals from the CPU, converts them into a plurality of pairs of PCI Express signals and sends one pair thereof to a first I/O port and another pair thereof the a second switch. The second switch converts the another pair of PCI Express signals into a plurality of pairs of PCI Express signals and sends one pair thereof to a second I/O port and another pair to a third switch and so on until a last switch converts the pair of PCI Express signals it receives into a plurality of pairs of PCI Express signals and sends one pair thereof to a last I/O port. The I/O ports are USB ports.

### CROSS-REFERENCE TO RELATED APPLICATIONS

This application claims priority to China Patent Application No. 201510399301.0 filed on Jul. 9, 2015, the contents of which are incorporated by reference herein.

### FIELD

The subject matter herein generally relates to a computer, and in particular to a system for expansion of input/output ports of a computer.

### BACKGROUND

Following the advancement of information technology, communication of information between different computer devices becomes more and more popular. A quantity of the information could be very large such as high definition audiovisual information. The communication could be performed through wired input/out (I/O) ports.

Universal Serial Bus (USB) ports are wired I/O ports that include a simple structure, ease of use, and hot plug in configuration. A South Bridge or a Platform Controller Hub (PCH) interconnects the USB ports and a central processing unit (CPU) whereby the processing speed for the information from the USB ports is limited.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an architecture of a computer I/O port system in accordance with the present disclosure.

FIG. 2 is a block diagram showing a detailed structure of the architecture of the computer I/O port system of FIG. 1, in accordance with a first embodiment of the present disclosure.

FIG. 3 is a block diagram showing a detailed structure of the architecture of the computer I/O port system of FIG. 1, in accordance with a second embodiment of the present disclosure.

FIG. 4 is a block diagram showing a detailed structure of the architecture of the computer I/O port system of FIG. 1, in accordance with a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to a computer I/O port system.

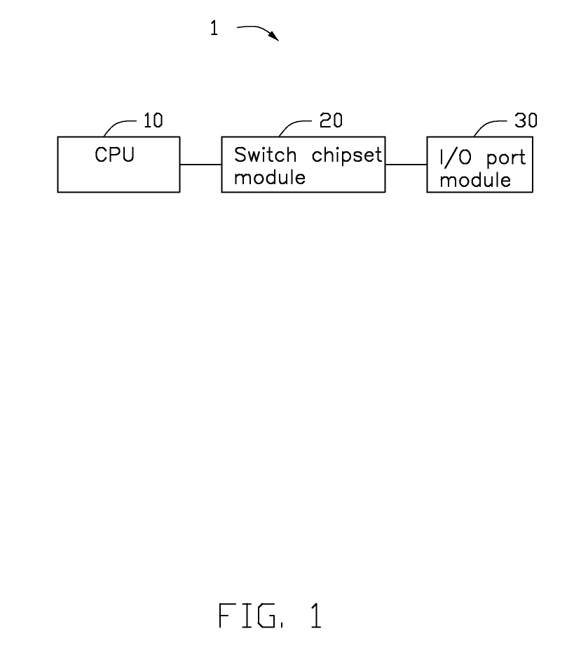

Referring to FIG. 1, a computer I/O port system 1 includes a central processing unit (CPU) 10, a switch chipset module 20 coupling with the CPU 10 and an I/O port module 30 coupling with the switch chipset module 20. The I/O port module 30 can be configured to couple to a plurality of external electronic devices (not shown) through Peripheral Component Interconnect Express (PCI Express) buses. The CPU 10 is configured to communicate information and process information from the external electronic devices. In at least one embodiment, the I/O port module 30 is a USB port module and the external electronic devices are USB-enabled devices. The CPU 10 can output a pair of PCI Express signals for communicating with a peripheral device. The CPU 10, the switch chipset module 20 and the I/O port module 30 connect with each other by PCI Express buses.

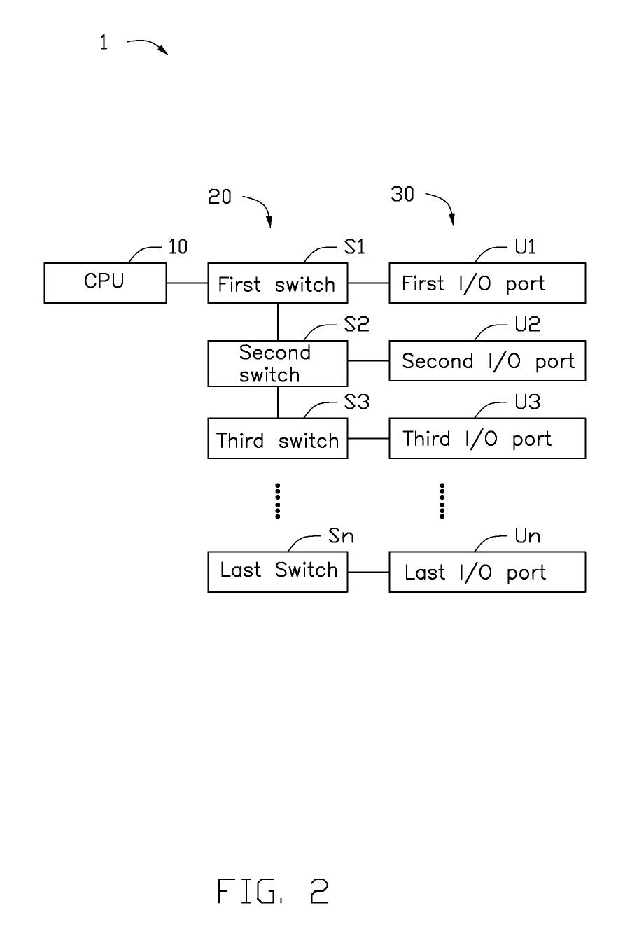

Referring to FIG. 2, the switch chipset module 20 of the computer I/O system 1 includes a plurality of switches S1-Sn each being a circuitry component that processes signals and governs signal flow. The I/O port module 30 includes a plurality of I/O ports U1-Un each of which can be a USB port. Each switch can connect to at least one I/O port through at least one PCI Express bus. Each 110 port can be coupled to a corresponding switch through a PCI Express bus. Each 110 port can be configured to be coupled to an external electronic device (not shown) through a PCI Express bus. Each switch can receive a pair of PCI Express signals and convert them into at least two pairs of PCI Express signals and transmit the converted at least two pairs of PCI Express signals to at least one I/O port and at least one switch in coupling therewith.

As illustrated in FIG. 2, a first switch S1 electrically is configured to be coupled to the CPU 10 through a PCI Express bus. The first switch S1 electrically couples with a second switch S2 through a PCI Express bus, which in turn is electrically coupled to a third switch S3 through a PCI Express bus and in the same pattern until a last switch Sn is electrically coupled by its previous switch Sn-1 (not shown) through a PCI Express bus. A first I/O port U1 is configured to be electrically coupled to the first switch S1 through a PCI Express bus; a second I/O port U2 is configured to be electrically coupled to the second switch S2 through a PCI Express bus; a third I/O port U3 is configured to be electrically coupled to the third switch S3 through a PCI Express bus and in the same pattern until a last I/O port Un is configured to be electrically coupled to the last switch Sn through a PCI Express bus.

The CPU 10 sends a pair of PCI Express signals to the first switch S1. The first switch S1 converts the pair of PCI Express signals into two pairs of PCI Express signals and sends one pair thereof to the first I/O port U1 and the other pair thereof to the second switch S2. The second switch S2 converts the other pair of PCI Express signals received from the first switch S1 into another two pairs of PCI Express signals and sends one pair thereof to the second 110 port U2 and the other pair thereof to the third switch S3. The third switch S3 converts the other pair PCI Express signals from the second switch S2 into still another two pairs of PCI Express signals and sends one pair thereof to the third I/O port U3 and the other pair thereof to a fourth switch S4 (not shown), and so one until the last switch Sn receives a pair of PCI Express signals from its previous switch Sn-1 (not shown) and converts the pair of PCI Express signals into last two pairs of PCI Express signals and sends one pair thereof into the last I/O port Un.

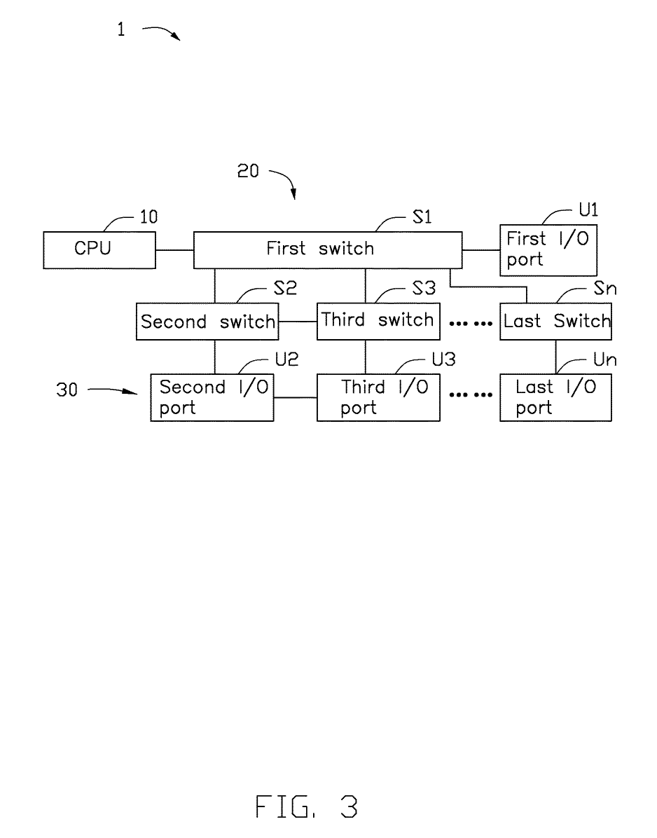

Referring to FIG. 3, the switch chipset module 20 of the computer I/O system 1 includes a plurality of switches S1-Sn. The I/O port module 30 includes a plurality of I/O ports U1-Un each of which can be a USB port. Each switch can connect to at least one I/O port through at least one PCI Express bus. Each I/O port can be coupled to a corresponding switch through a PCI Express bus. Each I/O port can be configured to be coupled to an external electronic device (not shown) through a PCI Express bus. Each switch can receive a pair of PCI Express signals and convert them into at least two pairs of PCI Express signals and transmit the converted at least two pairs of PCI Express signals to at least one I/O port and at least one switch in coupling therewith.

As illustrated in FIG. 3, the first switch S1 is configured to be electrically coupled to the CPU 10 through a PCI Express bus. The first switch S1 is configured to be electrically coupled to the first I/O port U1 of the I/O port module 30 through a PCI Express bus. The first switch S1 is configured to be electrically coupled to the second switch S2 through a PCI Express bus. The second switch S2 is configured to be electrically coupled to the second I/O port U2 through a PCI Express bus. The first switch S1 is configured to be electrically coupled to the third switch S3 through a PCI Express bus; the third switch S3 is configured to be electrically coupled to the third I/O port U3 via a PCI Express bus, and in the same pattern until the first switch S1 is electrically coupled to the last switch Sn via a PCI Express bus and the last switch Sn is electrically coupled to the last I/O port Un via a PCI Express bus. The second switch S2 is configured to be electrically coupled to the third switch S3 via a PCI Express bus which in turn is configured to be electrically coupled to the fourth switch S4 (not shown) via a PCI Express bus and in the same pattern until the last switch Sn is electrically coupled to its previous switch Sn-1 (not shown) via a PCI Express bus. The second I/O port U2 is configured to be electrically coupled to the third I/O port U3 via a PCI Express bus which in turn is configured to be electrically coupled to the fourth I/O port U4 (not shown) via a PCI Express bus and in the same pattern until the last I/O port Un is electrically coupled to its previous I/O port Un-1 (not shown) via a PCI Express bus.

The CPU 10 sends a pair PCI Express signals to the first switch S1. The first switch S1 converts the pair of PCI Express signals into a plurality of pairs of PCI Express signals and sends one pair thereof to the first I/O port U1 and each of the other pairs thereof to a corresponding one of the switches S2-Sn. Each of the switches S2-Sn converts the pair of PCI Express signals that it receives from the first switch S1 into two pairs of PCI Express signals and sends one pair thereof to a corresponding one of the I/O ports U2-Un and the other pair thereof to a next switch, except the last switch Sn which has no next switch and only sends one pair of the two pairs of PCI Express signals it receives to the last I/O port Un.

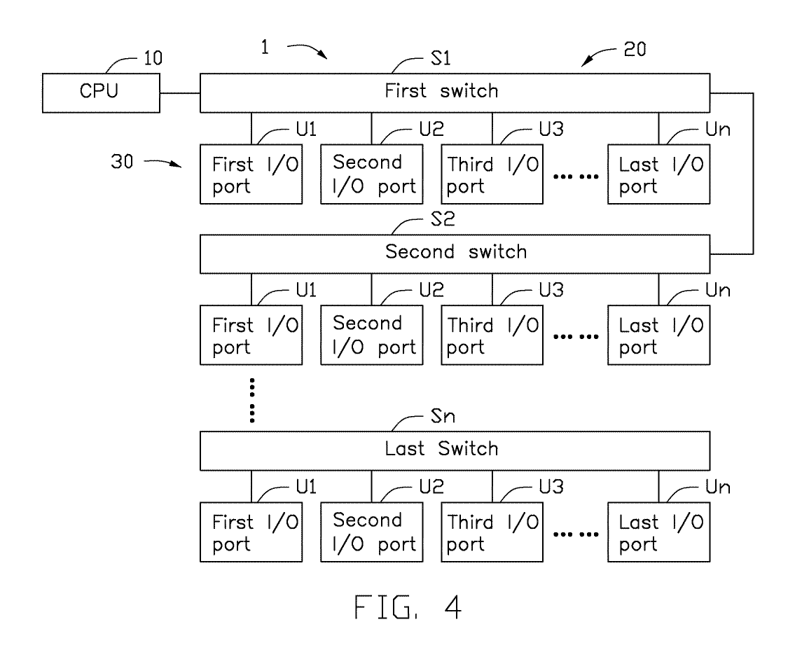

Referring to FIG. 4, the switch chipset module 20 of the computer I/O system 1 includes a plurality of switches S1-Sn. The I/O port module 30 includes a plurality of I/O ports U1-Un each of which can be a USB port. Each switch can connect to at least one I/O port through at least one PCI Express bus. Each I/O port can be coupled to a corresponding switch through a PCI Express bus. Each I/O port can be configured to be coupled to an external electronic device (not shown) through a PCI Express bus. Each switch can receive a pair of PCI Express signals and convert them into at least two pairs of PCI Express signals and transmit the converted at least two pairs of PCI Express signals to at least one I/O port and at least one switch in coupling therewith.

As illustrated in FIG. 4, the first switch S1 is configured to be electrically coupled to the CPU 10 via a PCI Express bus, the first, second, third to last I/O ports U1, U2, U3-Un via a plurality of PCI Express buses and the second switch S2 via a PCI Express bus. The second switch S2 is configured to be electrically coupled to the first, second, third to last I/O ports U1, U2, U3-Un via a plurality of PCI Express buses and the third switch S3 (not shown) via a PCI Express bus, and in the same pattern until the last switch Sn is electrically coupled to the first, second, third to last I/O ports U1, U2, U3-Un via a plurality of PCI Express buses. The last switch Sn is electrically coupled to its previous switch Sn-1 (not shown) via a PCI Express bus, wherein the previous switch Sn-1 is also in electrical connection with the first, second third to last I/O ports U1, U2, U3-Un via a plurality of PCI Express buses.

The CPU 10 sends a pair of PCI Express signals to the first switch S1 which converts them into a plurality of pairs of PCI Express signals and sends one pair thereof to the second switch S1 and the other pairs thereof to the first, second, third to last I/O ports U1, U2, U3-Un, respectively. The second switch S2 converts the pair of PCI Express signals received from the first switch S1 into a plurality of pairs of PCI Express signals and sends one pair thereof to the third switch S3 (not shown) and the other pairs thereof to the first, second, third to last I/O ports U1, U2, U3-Un, respectively, and in the same pattern until the last switch Sn converts the pair of PCI Express signals it receives from the second-last switch Sn-1 (not shown) into a plurality of pairs of PCI Express signals and sends one pair thereof to a corresponding one of the first, second, third to last I/O ports U1, U2, U3-Un.

In accordance with the present disclosure, the number of the I/O ports U1-Un can be arbitrarily adjusted to increase the versatility of a computer device having the computer I/O port system 1. Furthermore, the I/O ports U1-Un which are USB ports connect with the CPU 10 via PCI Expresses buses, whereby the transmission speed of information from the I/O ports U1-Un to the CPU 10 can be greatly enhanced; thus, the I/O ports U1-Un can be used in handling communication of high quantity of information in high speed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computer input/output (I/O) port system comprising:
a central processing unit (CPU);
a plurality of switches coupled to the CPU;
a plurality of Peripheral Component Interconnect Express (PCI Express) buses coupled to the CPU; and
a plurality of I/O ports, each of the plurality of I/O ports and the switches and the CPU being electrically connected together via the plurality of Peripheral Component Interconnect Express (PCI Express) buses;
a first switch of the plurality of switches configured to be electrically coupled to the CPU via a first PCI Express bus of the plurality of PCI express buses, at least a first I/O port of the plurality of I/O ports via at least a second PCI Express bus of the plurality of PCI express buses, and at least a second switch of the plurality of switches via at least a third PCI express bus of the plurality of PCI express buses; and
wherein the CPU sends a pair of PCI Express signals to the first switch, and the first switch is configured to convert the pair of PCI Express signals into a plurality of pairs of PCI Express signals and send at least one pair thereof to the at least a first I/O port and at least another pair thereof to the at least a second switch.

2. The computer I/O port system of claim 1, wherein the first switch electrically connects with the first I/O port and the second switch, the plurality of pairs of PCI Express signals include two pairs of PCI Express signals with one pair thereof being sent to the first I/O port from the first switch and the other pair thereof being sent to the second switch from the first switch.

3. The computer I/O port system of claim 2, wherein the I/O ports are Universal Serial Bus (USB) ports.

4. The computer I/O port system of claim 1, wherein the first switch electrically connects with the first I/O port and others of the plurality of switches, one pair of the plurality of pairs of PCI Express signals being sent to the first I/O port from the first switch and other pairs of the plurality of pairs of PCI Express signals being sent to the others of the plurality of switches.

5. The computer I/O port system of claim 4, wherein the second switch electrically couples with a third switch via a fourth PCI Express bus and a second I/O port via a fifth PCI Express bus.

6. The computer I/O port system of claim 5, wherein the I/O ports are USB ports.

7. The computer I/O port system of claim 1, wherein the first switch electrically connects with the plurality of I/O ports and the second switch, one pair of the plurality of pairs of PCI Express signals being sent to the second switch from the first switch and other pairs of the plurality of pairs of PCI Express signals being sent to the plurality of I/O ports from the first switch.

8. The computer I/O port system of claim 7, wherein the I/O ports are USB ports.

9. A computer I/O port system comprising:
a central processing unit (CPU);
a switch chipset module electrically connecting with the CPU via a Peripheral Component interconnect Express (PCI Express) bus; and
a Universal Serial Bus (USB) port module electrically connecting with the switch chipset module via a PCI Express bus.

10. The computer I/O port system of claim 9, wherein the switch chipset module includes a plurality of switches and the USB port module includes a plurality of USB ports, a first switch being electrically connected with the CPU, at least a second switch and at least a first USB port.

11. The computer I/O port system of claim 10, wherein the first switch is electrically connected with the second switch and the first USB port, the CPU sending a pair of PCI Express signals to the first switch, the first switch converting the pair of PCI Express signals into two pairs of PCI Express signals with one pair thereof being sent by the first switch to the second switch and the other pair thereof being sent by the first switch to the first USB port.

12. The computer I/O port system of claim 11, wherein the second switch electrically connects with a second USB port and a third switch.

13. The computer I/O port system of claim 10, wherein the first switch is electrically connected with the first USB port and others of the plurality of switches, the CPU sending a pair of PCI Express signals to the first switch, the first switch converting the pair of PCI Express signals into a plurality of pairs of PCI Express signals with one pair thereof being sent by the first switch to the first USB port and other pairs thereof being sent to by the first switch to the others of the plurality of switches.

14. The computer I/O port system of claim 13, wherein the second switch electrically connects with a second USB port and a third switch.

15. The computer I/O port system of claim 10, wherein the first switch is electrically connected with the plurality of USB ports and the second switch, the CPU sending a pair of PCI Express signals to the first switch, the first switch converting the pair of PCI Express signals into a plurality of pairs of PCI Express signals with one pair thereof being sent by the first switch to the second switch and other pairs thereof being sent to by the first switch to the plurality of USB ports.

16. The computer I/O port system of claim 15, wherein the second switch is electrically connected with the plurality of USB ports and a third switch.
